(19) United States
(12) Patent Application Publication
(10) Pub. No.: US 2023/0115974 A1
(43) Pub. Date: Apr. 13, 2023

(54) SPECIFICATION DESCRIPTION PROGRAM AND SPECIFICATION DESCRIPTION METHOD

(71) Applicant: DAIKIN INDUSTRIES, LTD., Osaka (JP)

(72) Inventor: Kousuke KIBO, Osaka (JP)

(21) Appl. No.: 17/907,297

(22) PCT Filed: Mar. 18, 2021
(86) PCT No.: PCT/JP2021/011094

§ 371 Date: Sep. 26, 2022

(30) Foreign Application Priority Data
Mar. 31, 2020 (JP) 2020-062591

(51) Int. Cl. G06F 9/445

(52) U.S. Cl. CPC G06F 9/445

(57) ABSTRACT

The present disclosure provides a specification description program and a specification description method that allows a user to create processing contents of a plurality of processes in a simple manner when designing the plurality of processes to be executed in a plurality of devices. A specification description program causes a computer to execute a receiving process for receiving processing contents of a plurality of processes to be executed in a plurality of devices. The receiving process further provides a user with a unique representation method as a selectable function. The unique representation method indicates that processing contents are targeted for one or more devices of a same type among the plurality of devices.

### TECHNICAL FIELD

The present disclosure relates to a specification description program and a specification description method.

### BACKGROUND ART

In general, when designing a plurality of processes to be executed in a plurality of devices constituting a device system, a writer is required to create processing contents of the plurality of processes while taking into account the number of devices of the same type included in the device system.

### RELATED-ART DOCUMENTS

### Patent Documents

Patent Document 1: Japanese Laid-Open Patent Publication No. 2017-091134

Patent Document 2: Japanese Laid-Open Patent Publication No. 2013-088873

Patent Document 3: WO 2014/170970

### SUMMARY OF THE INVENTION

### Problem to be Solved by the Invention

In many cases, when a writer designs processes, the device configuration (such as the number of devices of the same type) of an individual device system is not specifically determined. Therefore, in order to create processing contents while taking into account the number of devices, the writer is required to create the processing contents under the assumption of various device configurations, thus resulting in a complicated description.

The present disclosure provides a specification description program and a specification description method that allow a user to create processing contents of a plurality of processes in a simple manner when designing the plurality of processes to be executed in a plurality of devices.

### MEANS TO SOLVE THE PROBLEM

A first aspect of the present disclosure provides a specification description program for causing a computer to execute

a receiving process for receiving processing contents of a plurality of processes to be executed in a plurality of devices,

wherein the receiving process further provides a user with a unique representation method as a selectable function, the unique representation method indicating that processing contents are targeted for one or more devices of a same type among the plurality of devices.

The first aspect of the present disclosure can provide a specification description program that allow a user to create processing contents of a plurality of processes in a simple manner when designing the plurality of processes to be executed in a plurality of devices.

A second aspect of the present disclosure provides the specification description program according to the first aspect, wherein the receiving process provides the user with a unique representation method for a predetermined process as a selectable function, the unique representation method for indicating that the predetermined process is executed for the one or more devices of the same type.

A third aspect of the present disclosure provides the specification description program according to the first aspect, wherein the receiving process provides the user with a unique representation method for a device variable, included in processing contents of a predetermined process, as a selectable function, the unique representation method indicating that a statistic is calculated for variables of any or all of the one or more devices of the same type.

A fourth aspect of the present disclosure provides the specification description program according to the first aspect, wherein the receiving process provides the user with a unique representation method for a conditional statement, included in processing contents of a predetermined process, as a selectable function, the unique representation method indicating that the conditional statement is determined for any or all of the one or more processes of the same type.

A fifth aspect of the present disclosure provides the specification description program according to the first aspect, further causing the computer to execute a generation process for generating a source code from the processing contents received in the receiving process.

A sixth aspect of the present disclosure provides the specification description program according to the fifth aspect, wherein the generation process complements the processing contents based on the unique representation method when generating the source code, the unique representation method being selected by the user.

A seventh aspect of the present disclosure provides the specification description program according to the first aspect, further causing the computer to execute a determination process for determining consistency of the processing contents based on the unique representation method, the unique representation method being selected by the user.

An eighth aspect of the present disclosure provides a specification description method including

a receiving process for receiving processing contents of a plurality of processes to be executed in a plurality of devices,

wherein the receiving process further provides a user with a unique representation method as a selectable function, the unique representation method indicating that processing contents are targeted for one or more devices of a same type among the plurality of devices.

The eighth aspect of the present disclosure can provide a specification description method that allows a user to create processing contents of a plurality of processes in a simple manner when designing the plurality of processes to be executed in a plurality of devices.

### BRIEF DESCRIPTION OF THE DRAWINGS

FIG. 1 is a diagram illustrating an example of a usage scenario of a design work support apparatus;

FIG. 2 is a diagram illustrating an example of a hardware configuration of the design work support apparatus;

FIG. 3 is a diagram illustrating a specific example of hierarchical data;

FIG. 4 is a flowchart illustrating a flow of a specification description process;

FIG. 5 is a diagram illustrating an example of a functional configuration of a specification description unit;

FIG. 6 is a first diagram illustrating a specific example of a unique representation method for a process;

FIG. 7 is a second diagram illustrating a specific example of a unique representation method for a process;

FIG. 8A is a first diagram illustrating a specific example of a unique representation method for a device variable;

FIG. 8B is a second diagram illustrating a specific example of a unique representation method for a device variable.

FIG. 8C is a third diagram illustrating a specific example of a unique representation method for a device variable;

FIG. 9 is a diagram illustrating a specific example of a unique representation method for a conditional statement; and

FIG. 10 is a diagram illustrating a specific example of a process performed by a determination unit.

### MODE FOR CARRYING OUT THE INVENTION

In the following, embodiments will be described with reference to the accompanying drawings. In the specification and drawings, elements having substantially the same functions or configurations are referred to by the same numerals and the description thereof will not be repeated.

### First Embodiment

### <Usage Scenario of Design Work Support Apparatus>

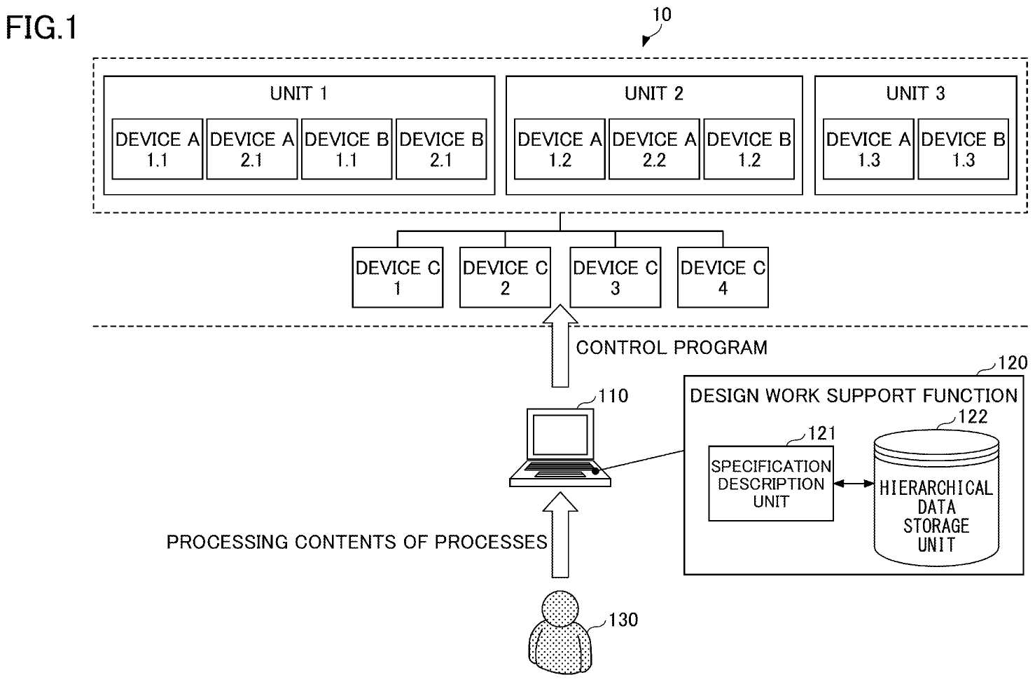

First, a usage scenario of a design work support apparatus when designing a plurality of processes to be executed in a plurality of devices constituting a device system will be described. FIG. 1 is a diagram illustrating an example of a usage scenario of a design work support apparatus. As illustrated in FIG. 1, for example, a design work support apparatus 110 provides a device system 10 with a control program for a plurality of processes to be executed in a plurality of devices constituting the device system 10.

In FIG. 1, the device system 10 includes a plurality of units. In each of the units, a plurality of types of devices (device(s) A and device(s) B) operate in cooperation with other devices (devices C) located outside the units. However, the device configuration of the device system 10, to which the control program is provided by the design work support apparatus 110, is not limited thereto. That is, the control program provided by the design work support apparatus 110 can be applied to various other device configurations, and the device configuration of the device system 10 illustrated in FIG. 1 is merely an example.

A design work support program is installed in the design work support apparatus 110, and the design work support apparatus 110 implements a design work support function 120 by executing the design work support program.

The design work support program includes a subprogram (for example, a specification description program) for implementing a plurality of subfunctions. When the design work support program is executed, the subprogram is also executed. That is, the plurality of subfunctions of the design work support function 120 include at least functions of a specification description unit 121.

When a user 130 has entered processing contents of a plurality of processes to be executed in a plurality of devices (devices A to C in the example of FIG. 1), the specification description unit 121 receives the processing contents. Further, for the plurality of processes whose processing contents have been received, the specification description unit 121 generates a source code while referring to hierarchical data stored in a hierarchical data storage unit 122.

For a device system (including a device system having any device configuration other than that of the device system 10) to which the control program can be applied, hierarchical data defines:
a hierarchical structure indicating an upper-lower level relationship between systems, units, and various types of devices; and
the maximum numbers of systems, units, and various types of devices. In the present embodiment, systems, units, and various types of devices are referred to as “element units”.

The specification description unit 121 provides the user 130 with a unique representation method, as a selectable function, indicating that processing contents of a process are targeted for a plurality of devices of the same type. When the unique representation method is selected by the user 130, the specification description unit 121 receives the unique representation method. In the present embodiment, the unique representation method provided by the specification description unit 121 includes:
a unique representation method for a process (a unique representation method indicating that a process is executed in a plurality of devices of the same type); and
a unique representation method for a device variable included in processing contents of a process (a unique representation method indicating that a statistic is calculated for variables of any or all of a plurality of devices of the same type); and
a unique representation method for a conditional statement included in processing contents of a process (a unique representation method indicating that a conditional statement is determined for any or all of a plurality of devices of the same type).

Further, when the specification description unit 121 has received a unique representation method for a process, the specification description unit 121 expands the process, for which the unique representation method has been described, into a number of processes corresponding to the maximum number of element units of the same type specified by the unique representation method, and generates a source code for processing contents of the expanded processes.

When the specification description unit 121 has received a unique representation method for a device variable included in processing contents of a process, the specification description unit 121 substitutes a statistic, calculated for any or all of a plurality of devices of the same type, for the device variable for which the unique representation method has been described, and generates a source code for processing contents of the process.

When the specification description unit 121 has received a unique representation method for a conditional statement included in processing contents of a process, the specification description unit 121 expands the conditional statement into a number of conditional statements targeted for any or all of element units of the same type, and generates a source code for the processing contents that include the expanded conditional statements.

Further, the specification description unit 121 determines the consistency of processing contents of a process, based on a unique representation method for the process. The specification description unit 121 refers to the hierarchical data stored in the hierarchical data storage unit 122 when determining the consistency.

Note that the specification description unit 121 may determine the consistency at a timing when processing contents of processes are entered by the user 130 or at a timing when the specification description unit 121 generates a source code for the processing contents of the processes.

As described above, the specification description unit 121 provides the user 130 with a unique representation method, as a selectable function, indicating that processing contents of a process are targeted for a plurality of devices of the same type. Further, when the unique representation method is selected by the user, the specification description unit 121 receives the unique representation method, performs a process in accordance with the received unique representation method, and generates a source code.

Accordingly, the user 130 can create processing contents of a plurality of processes in a simple manner when designing the plurality of processes to be executed in a plurality of devices.

In the present embodiment, suffixes are used to distinguish units or devices of the same type when the details of a process performed in accordance with a received unique representation method are described.

For example, in FIG. 1, for the sake of convenience, suffixes (“1”, “2”, and “3”) are added after “units” to distinguish the units. Similarly, in FIG. 1, for the sake of convenience, suffixes (“1.1”, “1.2”, “3”, “4”, and so on) are added after “devices A”, “devices B”, and “devices C” to distinguish the devices of the same type.

In each of the suffixes added to distinguish the “devices A” and added to distinguish the “devices B”, the right side of a decimal point (.) corresponds to a suffix of a unit to which the devices belong, and the left side of the decimal point (.) corresponds to a given number of consecutive numbers (indicating the first device, the second device, and the like) in the unit.

### <Hardware Configuration of Design Work Support Apparatus>

Next, a hardware configuration of the design work support apparatus 110 will be described.

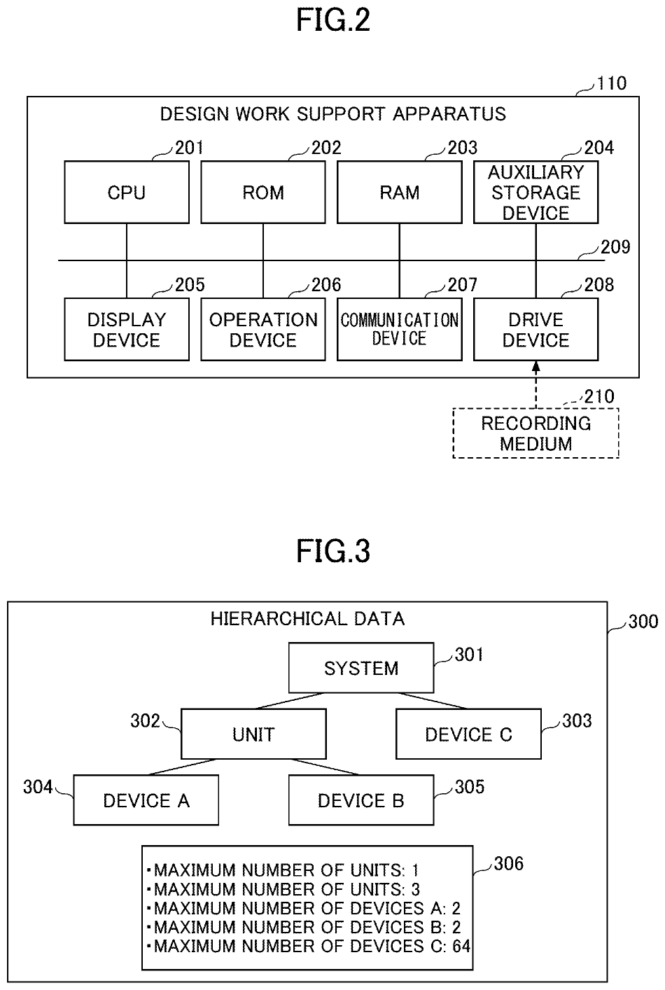

FIG. 2 is a diagram illustrating an example of a hardware configuration of the design work support apparatus.

As illustrated in FIG. 2, the design work support apparatus 110 includes a central processing unit (CPU) 201, a read-only memory (ROM) 202, and a random-access memory (RAM) 203. The CPU 201, the ROM 202, and the RAM 203 constitute what is known as a computer.

Further, the design work support apparatus 110 includes an auxiliary storage device 204, a display device 205, an operation device 206, a communication device 207, and a drive device 208. Note that the hardware components of the design work support apparatus 110 are connected with one another via a bus 209.

The CPU 201 is a calculation device that executes various programs (for example, the design work support program and the like) installed in the auxiliary storage device 204.

The ROM 202 is a non-volatile memory. The ROM 202 functions as a main storage device that stores various programs, data, and the like necessary for the CPU 201 to execute various programs installed in the auxiliary storage device 204. Specifically, the ROM 202 functions as a main storage device that stores a boot program or the like, such as a basic input/output system (BIOS) or an extensible firmware interface (EFI).

The RAM 203 is a volatile memory such as a dynamic random-access memory (DRAM) or a static random-access memory (SRAM). The RAM 203 functions as a main storage device that provides a work area in which various programs installed in the auxiliary storage device 204 are loaded when executed by the CPU 201.

The auxiliary storage device 204 is an auxiliary storage device that stores various programs and data used when the various programs are executed. For example, the hierarchical data storage unit 122 is implemented by the auxiliary storage device 204.

The display device 205 is a display device that displays an internal state of the design work support apparatus 110. The operation device 206 is an input device used when the user 130 of the design work support apparatus 110 inputs various instructions into the design work support apparatus 110.

The communication device 207 is a communication device that is connected to a network (not illustrated) and performs communication.

The drive device 208 is a device in which a recording medium 210 is set. The recording medium 210 includes a medium for optically, electrically, or magnetically recording information, such as a CD-ROM, a flexible disk, or a magneto-optical disc. Further, the recording medium 210 may include a semiconductor memory or the like that electrically records information, such as a ROM, a flash memory, or the like.

Various programs to be installed in the auxiliary storage device 204 are installed by, for example, setting the distributed recording medium 210 in the drive device 208 and reading the various programs recorded in the recording medium 210 by the drive device 208. Alternatively, various programs to be installed in the auxiliary storage device 204 may be installed by being downloaded from the network via the communication device 207.

### <Specific Example of Hierarchical Data>

Next, a specific example of hierarchical data stored in the hierarchical data storage unit 122 will be described. FIG. 3 is a diagram illustrating a specific example of hierarchical data. As illustrated in FIG. 3, in the present embodiment, a device system to which the control program can be applied is configured by element units of a system 301, a unit 302, and various types of devices (devices A to C) 303 to 305.

In the example of hierarchical data 300 illustrated in FIG. 3, the system 301 is at the highest level in a hierarchy. Further, the unit 302 and the device 303 are one level lower than the system 301 in the hierarchy. Further, the device 304 and the device 305 are one level lower than the unit 302 in the hierarchy.

Further, in the example of the hierarchical data 300 illustrated in FIG. 3, the maximum number of element units of the system 301, the units 302, and various types of the devices 303 to 305 are defined as follows (see reference numeral 306).
Maximum number of systems=“1”
Maximum number of units=“3”
Maximum number of devices A=“2”
Maximum number of devices B=“2”
Maximum number of devices C=“64”

According to the example of the hierarchical data 300 illustrated in FIG. 3, a maximum of six devices A can be installed in the device system to which the control program can be applied (if the maximum number of devices A is installed in each unit). Note that the individual device system 10 illustrated in FIG. 1 includes a unit in which the maximum number of devices A is not installed. Therefore, the total number of devices A is five.

Similarly, according to the example of the hierarchical data 300 illustrated in FIG. 3, a maximum of six devices B can be installed in the device system to which the control program can be applied (if the maximum number of devices B is installed in each unit). Note that the individual device system 10 illustrated in FIG. 1 includes units in which the maximum number of devices B is not installed. Therefore, the total number of devices B is five.

Similarly, according to the example of the hierarchical data 300 illustrated in FIG. 3, a maximum of 64 devices C can be installed in the device system to which the control program can be applied. Note that in the individual device system 10 illustrated in FIG. 1, four devices C are installed.

As described above, the specification description unit 121 generates a source code based on the hierarchical data 300. Therefore, the specification description unit 121 can apply the control program to a device system having any of various device configurations covered by the hierarchical data 300.

### <Flow of Specification Description Process>

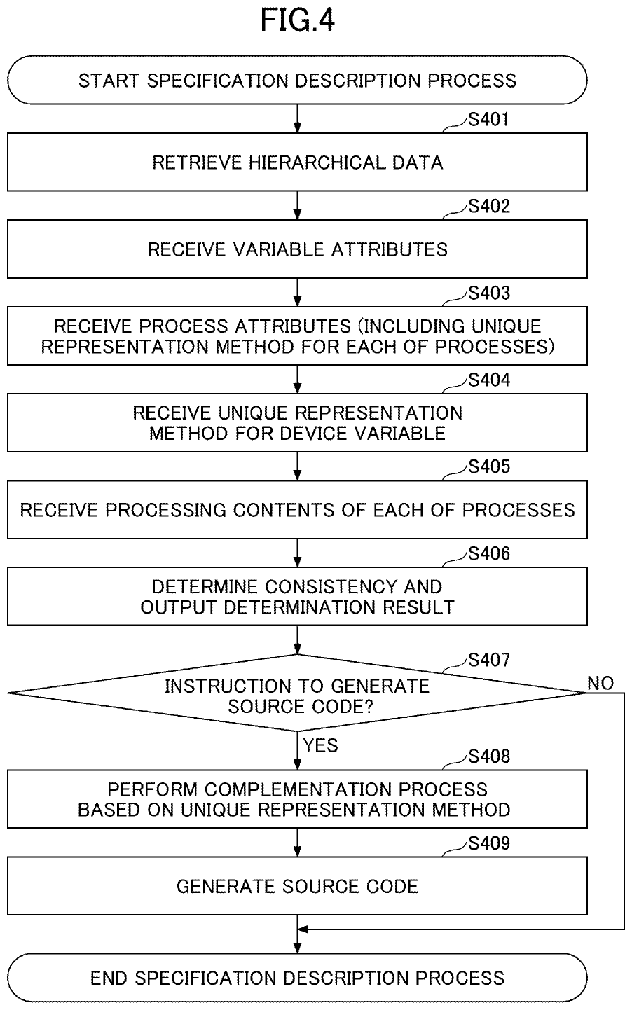

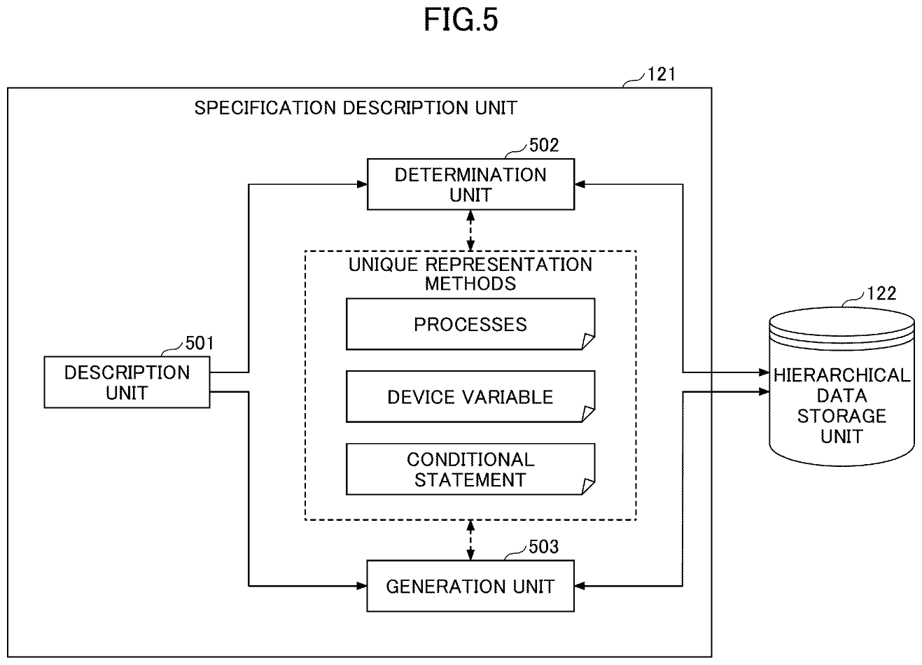

Next, a flow of a specification description process performed by the specification description unit 121 will be described. FIG. 4 is a flowchart illustrating a flow of a specification description process. In response to an instruction from the user 130, the specification description unit 121 is started, and in doing so, the specification description process illustrated in FIG. 3 is executed.

In step S401, the specification description unit 121 retrieves the hierarchical data 300 from the hierarchical data storage unit 122.

In step S402, in a case where the user 130 inputs variable attributes to be included in processing contents of each of processes, the specification description unit 121 receives the variable attributes.

In step S403, in a case where the user 130 inputs process attributes, the specification description unit 121 receives the process attributes. The process attributes received by the specification description unit 121 include a unique representation method for each of the processes, the unique representation method being selected by the user 130.

In step S404, in a case where the user 130 inputs a unique representation method for a device variable to be included in the processing contents of each of the processes, the specification description unit 121 receives the unique representation method for the device variable. The specification description unit 121 receives the unique representation method for the device variable to be included in the processing contents of each of the processes via a predetermined screen.

In step S405, in a case where the user 130 enters the processing contents of each of the processes, the specification description unit 121 receives the processing contents. The processing contents received by the specification description unit 121 include variables (including the device variable for which the unique representation method has been described). Further, the processing contents received by the specification description unit 121 include conditional statements (including a conditional statement for which a unique representation method has been described).

In step S406, the specification description unit 121 determines the consistency of the processing contents, based on the unique representation method for each of the processes whose processing contents have been received in step S405. The specification description unit 121 outputs the determination result of the consistency to the user 130. The user 130 corrects processing contents of a corresponding process according to the determination result.

In step S407, the specification description unit 121 determines whether an instruction to generate a source code is input by the user 130. If the specification description unit 121 determines that an instruction to generate a source code is not input in step S407 (NO in step S407), the specification description unit 121 ends the specification description process.

Conversely, in step S407, if the specification description unit 121 determines that an instruction to generate a source code is input in step S407 (YES in step S407), the specification description unit 121 causes the specification description process to proceed to step S408.

In step S408, the specification description unit 121 performs a complementation process. The complementation process includes:
expanding a process, for which a unique representation method has been described, into a number of processes corresponding to the maximum number of element units of the same type specified by the unique representation method;
substituting a statistic, calculated for any or all of a plurality of devices of the same type, for a device variable for which a unique representation method has been described; and
expanding a conditional statement, for which a unique representation method has been described, into conditional statements for any or all of element units of the same type.

In step S409, the specification description unit 121 generates a source code for the processes for which the complementation process has been performed, and ends the specification description process.

### <Functional Configuration of Specification Description Unit>

Next, a functional configuration of the specification description unit 121 will be described. FIG. 5 is a diagram illustrating an example of a functional configuration of the specification description unit. As illustrated in FIG. 5, the specification description unit 121 includes a description unit 501, a determination unit 502, and a generation unit 503.

The description unit 501 performs a receiving process. Specifically, the description unit 501 provides the user 130 with a unique representation method as a selectable function. The unique representation includes:
a unique representation method for a process;
a unique representation method for a device variable included in processing contents of a process; and
a unique representation method for a conditional statement included in processing contents of a process.

In addition, in a case where the user 130 enters or selects the following, the description unit 501 receives the following:
attributes of each variable;
attributes of each process (including a unique representation method for each process);
a unique representation method for a device variable; and
processing contents of each process (including a unique representation method for a conditional statement).

The description unit 501 indicates processing contents of each of processes to the determination unit 502. Further, the description unit 501 indicates the processing contents of each of the processes to the generation unit 503 in a case where the user 130 inputs an instruction to generate a sources code.

The determination unit 502 performs a determination process. Specifically, when processing contents of each of processes are indicated by the description unit 501, the determination unit 502 determines the consistency of the indicated processing contents of each of the processes based on a unique representation method for each of the processes. Note that the determination unit 502 refers to the hierarchical data 300 stored in the hierarchical data storage unit 122 when determining the consistency. Further, if the determination unit 502 determines that any processing contents are not consistent, the determination unit 502 notifies the user 130 of the determination result.

The generation unit 503 performs a generation process. Specifically, when the processing contents of each of processes are indicated by the description unit 501, the generation unit 503 performs a complementation process based on a unique representation method (for each of the processes, a device variable, and a conditional statement) and generates a source code.

### <Specific Examples of Unique Representation Methods for Processes>

Next, as a specific example of a unique representation method for a process,

variable attributes,

processing contents of a process for which a unique representation method has been described, and

a complementation process when the unique representation method for the process has been received, will be described. In specific examples below, the device system 10 is an air conditioning system, the devices A are compressors, the devices B are heat exchangers, and the devices C are indoor units.

(1) First Specific Example of Unique representation method for Process

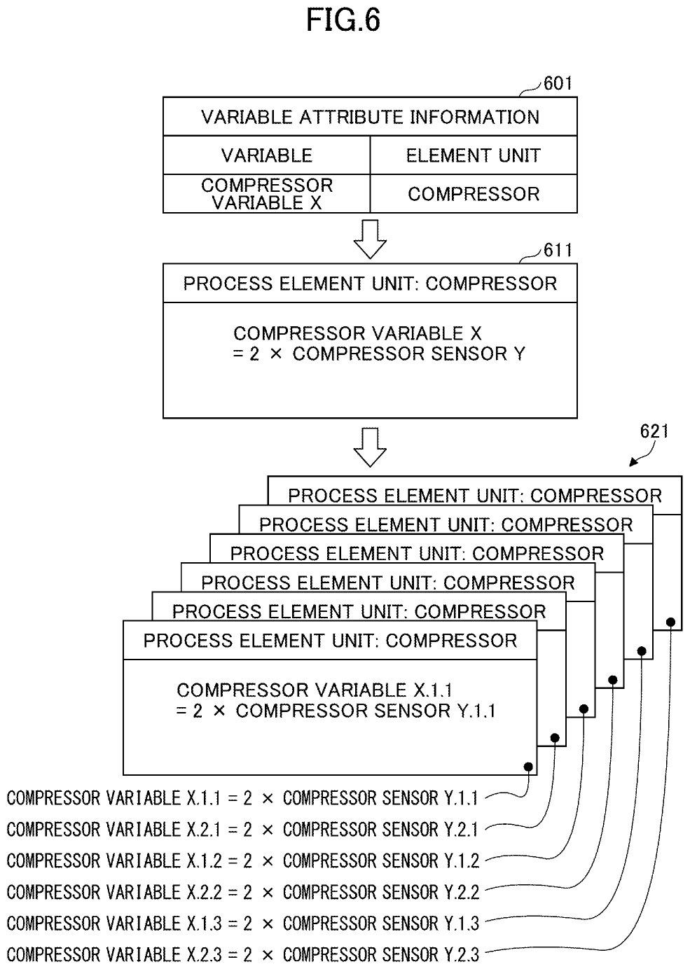

First, a first specific example of a unique representation method for a process will be described. FIG. 6 is a first diagram illustrating a specific example of a unique representation method for a process. In FIG. 6, variable attribute information 601 is an example of variable attributes selected by the user 130.

As illustrated in FIG. 6, the variable attribute information 601 includes, as information items, “variable” and “element unit”. In “variable”, a variable name is entered. In “element unit”, an element unit (“system”, “unit”, or “device”), for which the “variable” is defined, is entered based on the selection of the user 130. The variable attribute information 601 indicates that “compressor variable X” is a variable defined for each compressor.

It is assumed that with the variable attribute information 601 being entered, the description unit 501 of the specification description unit 121 has received “element unit: compressor” as a unique representation method for a process. In addition, it is assumed that the description unit 501 of the specification description unit 121 has received processing contents of a process 611 in which “compressor variable X” is entered.

In this case, when generating a source code, the generation unit 503 of the specification description unit 121 expands the process 611 into a number of processes corresponding to the maximum number of compressors included in the system (see reference numeral 621). In reference numeral 621, a suffix after “compressor variable X.” and “compressor sensor Y.” indicates a compressor to which a variable and a sensor belong. For example, for a variable or a sensor to which a suffix of “1.1” is added, the variable or the sensor belongs to the “compressor 1.1”. The compressor 1.1 is the first compressor belonging to the unit 1 as described above.

Specifically, according to the hierarchical data 300, the maximum number of compressors included in the system is “6”. Therefore, the generation unit 503 of the specification description unit 121 expands the process 611 into six processes. Further, the generation unit 503 of the specification description unit 121 substitutes a corresponding value (a value obtained by doubling the value of a corresponding compressor sensor in the example of FIG. 6) for each “compressor variable X”.

Accordingly, the user 130 can create processing contents of a plurality of processes in a simple manner by generating a source code after a unique representation method for each of the processes is received and a complementation process is performed.

(2) Second Specific Example of Unique representation method for Process

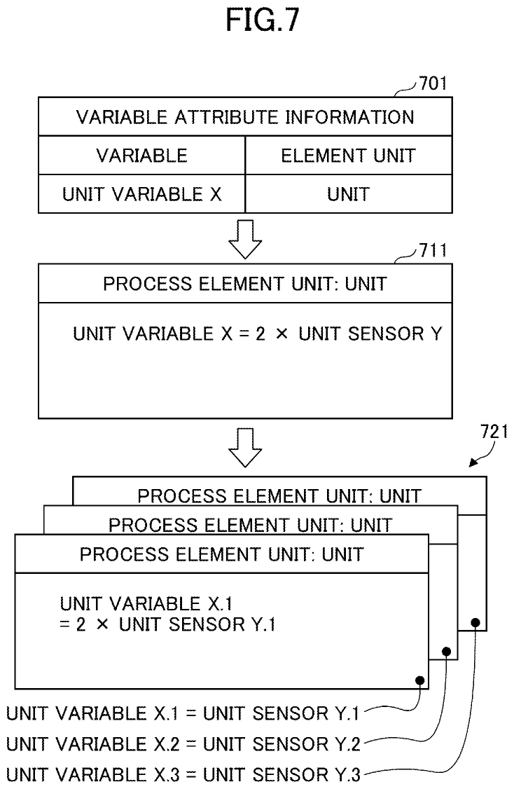

Next, a second specific example of a unique representation method for a process will be described. FIG. 7 is a second diagram illustrating a specific example of a unique representation method for a process. In FIG. 7, variable attribute information 701 is an example of variable attributes selected by the user 130. The variable attribute information 701 is similar to the variable attribute information 601 described with reference to FIG. 6.

The variable attribute information 701 in FIG. 7 indicates that “unit variable X” is a variable defined for each unit.

Similar to FIG. 6, it is assumed that, with the variable attribute information 701 being entered, the description unit 501 of the specification description unit 121 has received “element unit: unit” as a unique representation method for a process. In addition, it is assumed that the description unit 501 of the specification description unit 121 has received processing contents of a process 711 in which “unit variable X” is entered.

In this case, when generating a source code, the generation unit 503 of the specification description unit 121 expands the process 711 into a number of processes corresponding to the maximum number of units included in the system (see reference numeral 721).

Specifically, according to the hierarchical data 300, the maximum number of units included in the system is “3”. Therefore, the generation unit 503 of the specification description unit 121 expands the process 711 into three processes. Further, the generation unit 503 of the specification description unit 121 substitutes a corresponding value (a value obtained by doubling the value of a corresponding unit sensor in the example of FIG. 7) for each “unit variable X”.

Accordingly, the user 130 can create processing contents of a plurality of processes in a simple manner by generating a source code after a unique representation method for each of the processes is received and a complementation process is performed.

### <Specific Examples of Unique Representation Method for Device Variables>

Next, as a specific example of a unique representation method for a device variable included in processing contents of a process,
a screen for receiving a unique representation method for a device variable;
processing contents of a process in which the unique representation method for the device variable is included; and
a complementation process when the unique representation method for the device variable has been received, will be described.

### (1) First Calculation Example of Device Variable

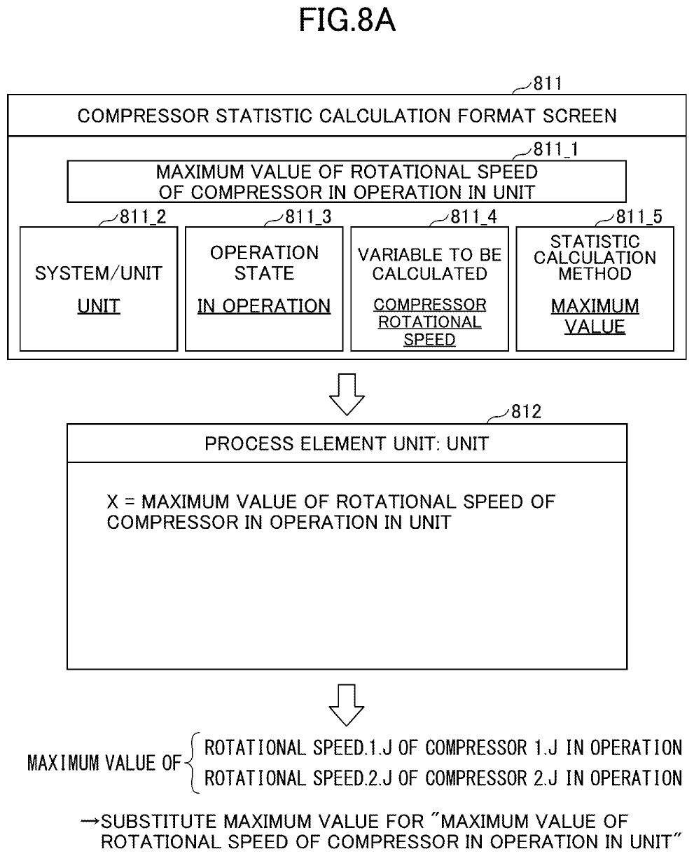

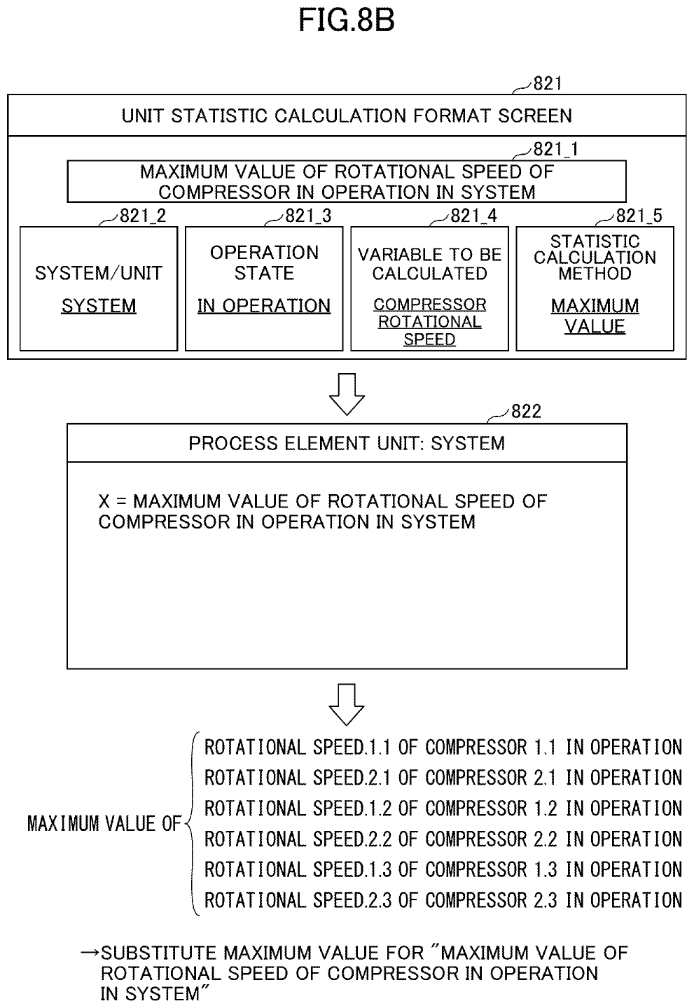

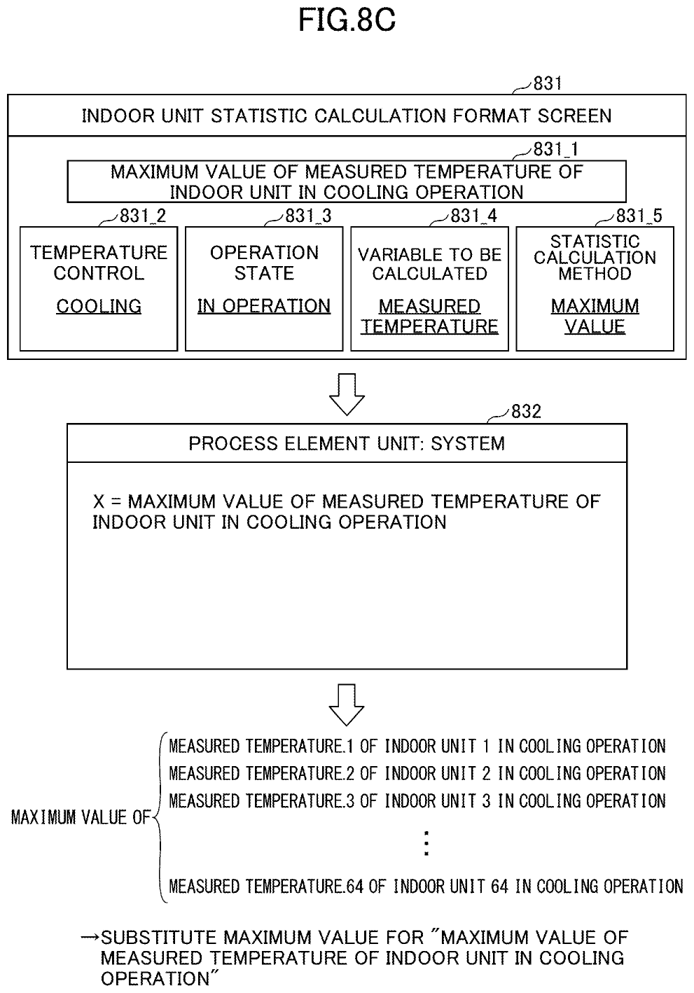

FIG. 8A is a first diagram illustrating a specific example of a unique representation method for a device variable. As illustrated in FIG. 8A, the description unit 501 of the specification description unit 121 receives a unique representation method for a variable of a compressor, which is an element unit, via a unit statistic calculation format screen 811, for example.

The unit statistic calculation format screen 811 includes an input field 811_1 for inputting a device variable name. In the example of FIG. 8A, the “maximum value of the rotational speed of a compressor in operation in a unit” is input in the input field 811_1.

Further, the unit statistic calculation format screen 811 includes a field 811_2 for specifying either “system” or “unit”, and a field 811_3 for specifying an operation state. In addition, the unit statistic calculation format screen 811 includes a field 811_4 for specifying a variable to be calculated, and a field 811_5 for specifying a statistic calculation method.

In the example of FIG. 8A, “unit” is specified in the field 811_2, “in operation” is specified in the field 811_3, “compressor rotational speed” is specified in the field 811_4, and “maximum value” is specified in the field 811_5. The input field 811_1 is automatically input based on the contents specified in the fields 811_2 to 811_5.

In the example of FIG. 8A, the “maximum value of the rotational speed of a compressor in operation in a unit” is calculated by:
acquiring the rotational speeds of compressors in operation in a unit; and
identifying the maximum rotational speed among the rotational speeds of the compressors.

It is assumed that “X=the maximum value of the rotational speed of a compressor in operation in a unit”, which includes the unique representation method for the device variable, has been entered by the user 130 as processing contents of a process 812.

In this case, the generation unit 503 of the specification description unit 121 performs a complementation process by acquiring the rotational speeds of all compressors in operation in a unit, and identifying the maximum rotational speed among the rotational speeds of the compressors.

Specifically, in the case of unit j, the generation unit 503 of the specification description unit 121 identifies the maximum rotational speed among the rotational speeds of a compressor 1.j and a compressor 2.j in operation in the unit j, and substitutes the identified maximum rotational speed for the “maximum value of the rotational speed of a compressor in operation in a unit”.
Note that according to the hierarchical data 300, j takes either “1”, “2”, or “3”.

### (2) Second Calculation Example of Device Variable

FIG. 8B is a second diagram illustrating a specific example of a unique representation method for a device variable. As illustrated in FIG. 8B, the description unit 501 of the specification description unit 121 receives a unique representation method for a variable of a compressor, which is an element unit, via a compressor statistic calculation format screen 821, for example.

The compressor statistic calculation format screen 821 includes an input field 821_1 for inputting a device variable name. In the example of FIG. 8B, the “maximum value of the rotational speed of a compressor in operation in the system” is input in the input field 821_1.

Further, the compressor statistic calculation format screen 821 includes a field 821_2 for specifying either “system” or “unit”, and a field 821_3 for specifying an operation state. In addition, the compressor statistic calculation format screen 821 includes a field 821_4 for specifying a variable to be calculated, and a field 821_5 for specifying a statistic calculation method.

In the example of FIG. 8B, “system” is specified in the field 821_2, “in operation” is specified in the field 821_3, “compressor rotational speed” is specified in the field 821_4, and “maximum value” is specified in the field 821_5. The input field 821_1 is automatically input based on the contents specified in the fields 821_2 to 821_5.

In the example of FIG. 8B, the “maximum value of the rotational speed of a compressor in operation in the system” is calculated by:
acquiring the rotational speeds of compressors in operation in the system; and
identifying the maximum rotational speed among the rotational speeds of the compressors.

It is assumed that “X=the maximum value of the rotational speed of a compressor in operation in the system”, which includes the unique representation method for the device variable, has been entered by the user 130 as processing contents of a process 822.

In this case, the generation unit 503 of the specification description unit 121 performs a complementation process by acquiring the rotational speeds of all compressors in operation in a system, and identifying the maximum rotational speed among the rotational speeds of the compressors.

Specifically, the generation unit 503 of the specification description unit 121 identifies the maximum rotational speed among the rotational speeds of compressors 1.1, 1.2, 2.1, 2.2, 3.1, and 3.2 in operation in the system, and substitutes the identified maximum rotational speed for the “maximum value of the rotational speed of a compressor in operation in a system”.
Note that in the case of the device system 10, the device system 10 does not include a compressor 3.2. Thus, the compressor rotational speed of the compressor 3.2 is identified as “Null”.

### (3) Third Calculation Example of Device Variable

FIG. 8C is a third diagram illustrating a specific example of a unique representation method for a device variable. As illustrated in FIG. 8C, the description unit 501 of the specification description unit 121 receives a unique representation method for a variable of an indoor unit, which is an element unit, via an indoor unit statistic calculation format screen 831, for example.

The indoor unit statistic calculation format screen 831 includes an input field 831_1 for inputting a device variable name. In the example of FIG. 8C, the “maximum value of the measured temperature of an indoor unit in cooling operation” is input in the input field 831_1.

Further, the indoor unit statistic calculation format screen 831 includes a field 831_2 for specifying a temperature control mode, and a field 831_3 for specifying an operation state, a field 831_4 for specifying a variable to be calculated, and a field 831_5 for specifying a statistic calculation method.

In the example of FIG. 8C, “cooling” is specified in the field 831_2, “in operation” is specified in the field 831_3, “measured temperature” is specified in the field 831_4, and “maximum value” is specified in the field 831_5. The input field 831_1 is automatically input based on the contents specified in the fields 831_2 to 831_5.

In the example of FIG. 8C, the “maximum value of the measured temperature of an indoor unit in cooling operation” is calculated by:
acquiring the measured temperatures of indoor units in operation in cooling mode; and
identifying the maximum measured temperature among the acquired measured temperatures of the indoor units.

It is assumed that “X=the maximum value of the measured temperature of an indoor unit in cooling operation”, which includes the unique representation method for the device variable, has been entered by the user 130 as processing contents of a process 832.

In this case, the generation unit 503 of the specification description unit 121 performs a complementation process by acquiring the measured temperatures of all indoor units in cooling operation in the system, and identifying the maximum measured temperature.

Specifically, the generation unit 503 of the specification description unit 121 identifies the maximum measured temperature among the measured temperatures of indoor units 1 to 64 in cooling operation in the system, and substitutes the identified maximum measured temperature for the “maximum value of the measured temperature of an indoor unit in cooling operation”. Note that in the case of the device system 10, the device system 10 does not include indoor units 5 to 64. Thus, the measured temperatures of the indoor units 5 to 64 in cooling operation are identified as “Null”.

### <Specific Example of Unique Representation Method for Conditional Statement>

Next, as a specific example of a unique representation method for a conditional statement, the following will be described:
processing contents of a process in which a unique representation method for a conditional statement is included; and
a complementation process when the unique representation method for the conditional statement has been received.

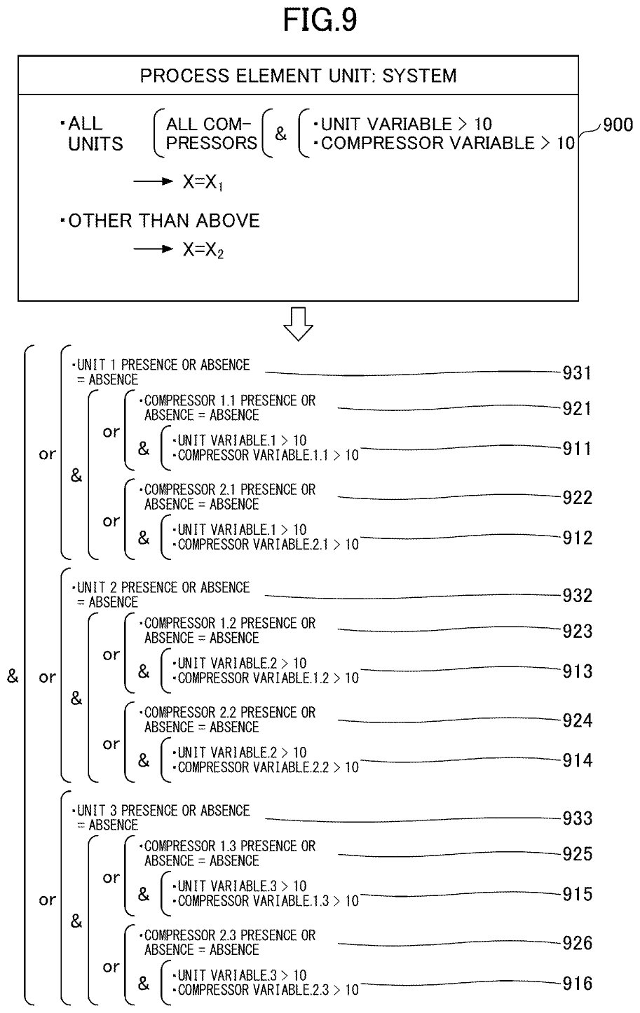

FIG. 9 is a specific example of a unique representation method for a conditional statement.

As illustrated in FIG. 9, it is assumed that “all units” and “all compressors”, which are unique representation methods for conditional statements, have been entered by the user 130 as processing contents of a process 900.

In this case, the generation unit 503 of the specification description unit 121 performs a complementation process by expanding a conditional statement into conditional statements targeted for compressors specified by a unique representation method (that is, targeted for all compressors included in all units).

Specifically, in the example of FIG. 9, the element unit of the process 900 is “system”, and “all units” is entered as the processing contents. Therefore, the generation unit 503 of the specification description unit 121 expands a conditional statement including a unit variable into a number of conditional statements corresponding to the maximum number (3) of units belonging to the system.

Further, in the example of FIG. 9, the element unit of the process 900 is “system”, and “all compressors”, which is at a lower level than “all units”, is entered as the processing contents. Therefore, after expanding the conditional statement including the unit variable into the number of conditional statements corresponding to the maximum number (3) of units, the generation unit 503 of the specification description unit 121 further expands, at the lower level, a conditional statement including a compressor variable into a number of conditional statements corresponding to the maximum number (2) of compressors in each of the units.

As a result, the generation unit 503 of the specification description unit 121 expands the conditional statement including the compressor variable into a number of conditional statements corresponding to the maximum number (3×2=6) of compressors belonging to the system (see reference numerals 911 to 916 and 921 to 926).

Note that when the generation unit 503 of the specification description unit 121 expands the conditional statement into the number of conditional statements corresponding to the maximum number of compressors, the compressors included in the expanded conditional statements are not necessarily present. Therefore, the generation unit 503 of the specification description unit 121 adds conditional statements indicating the presence or absence of the compressors (see reference numerals 921 to 926).

Similarly, when the generation unit 503 of the specification description unit 121 expands the conditional statement into the number of conditional statements corresponding to the maximum number of units, the units included in the expanded conditional statements are not necessarily present. Therefore, the generation unit 503 of the specification description unit 121 adds conditional statements indicating the presence or absence of the units (see reference numeral 931 to 933).

### <Specific Example of Process Performed by Determination Unit>

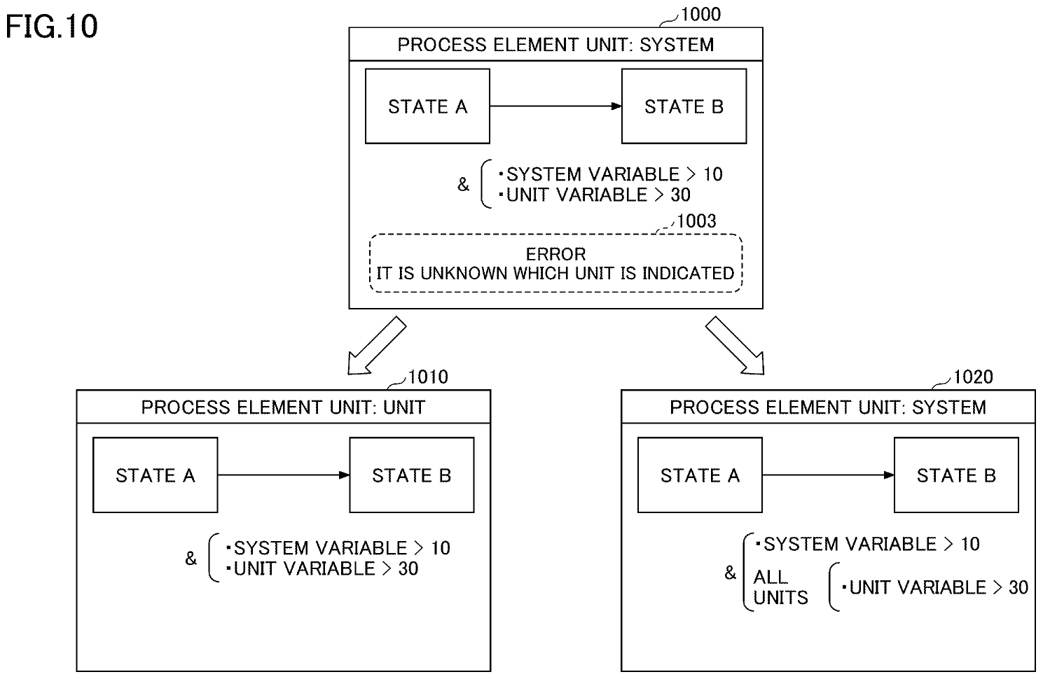

Next, a specific example of a process performed by the determination unit 502 will be described. FIG. 10 is a diagram illustrating a specific example of a process performed by the determination unit. As described above, the determination unit 502 determines whether processing contents of each process are consistent based on a unique representation method.

In FIG. 10, a process 1000 is a process that is indicated by the description unit 501 and in which “element unit: system” is entered as a unique representation method for the process. According to conditional statements entered in processing contents of the process 1000, if a system variable is greater than 10 and a unit variable is greater than 30, the state of the system transitions from state A to state B.

As indicated in the hierarchical data 300, the system includes a plurality of units (3 units at the maximum). Therefore, when “element unit: system” is entered as the unique representation method for the process, it is unknown which one of the three units is indicated by “unit variable>30” in the conditional statement.

In such a case, the determination unit 502 determines that the processing contents are not consistent, and notifies the user 130 of the determination result. In FIG. 10, an error message 1003 indicates the determination result notified to the user 130 by the determination unit 502.

If the error message 1003 is notified to the user 130, the user 130 correct the process 1000 by, for example,
correcting the unique representation method for the process 1000 (“element unit: system”) to “element unit: unit” (see a process 101); or
adding, as a unique representation method for a conditional statement, “all units” to the conditional statement included in the processing contents of the process 1000 (see a process 1020).

According to the process 1010, it is clear that “unit variable>30” is determined for unit variables of all of the units in the system. Thus, the error is resolved.

In addition, according to the process 1020, it is clear that “unit variable>30” is determined for unit variables of all of the units in the system. Thus, the error is resolved.

### <Summary>

As is clear from the above description, in response to the specification description program according to the first embodiment being executed, the specification description unit is configured to:
receive processing contents of a plurality of processes to be executed in a plurality of devices; and
provide a user with a unique representation method as a selectable function. The unique representation method indicates that processing contents of a process are targeted for one or more devices of the same type from among the plurality of devices.

Accordingly, the specification description unit provides a unique representation method as a selectable function, thereby allowing the user to create processing contents of a plurality of processes in a simple manner even when various device configurations are assumed.

That is, according to the first embodiment, a specification description program and a specification description method that allows a user to create processing contents of a plurality of processes in a simple manner when designing the plurality of processes to be executed in a plurality of devices, can be provided.

### Second Embodiment

In the first embodiment, the device system having the hierarchical structure configured by element units of the system, the unit, and the various types of devices has been described. However, the element units of the hierarchical structure of the device system are not limited thereto.

Further, in the first embodiment, the maximum numbers of systems, units, and various types of devices are indicated in the hierarchical data 300 of FIG. 3. However, the maximum numbers of systems, units, and various types of devices are not limited thereto.

Further, in the first embodiment, a maximum value is used as a statistic; however, the statistic is not limited thereto, and other statistics such as a minimum value, an average value, and a variance value may be calculated.

Although embodiments have been described above, it will be understood that various modifications may be made to the configurations and details thereof without departing from the spirit and scope of the claims.

This application is based on and claims priority to Japanese Patent Application No. 2020-062591, filed on Mar. 31, 2020, the entire contents of which are incorporated herein by reference.

### DESCRIPTION OF THE REFERENCE NUMERALS

10 device system
110 design work support apparatus
120 design work support function
121 specification description unit
122 hierarchical data storage unit
300 hierarchical data
501 description unit
502 determination unit
503 generation unit

1. A non-transitory recording medium having stored therein a specification description program for causing a computer to execute
a receiving process for receiving processing contents of a plurality of processes to be executed in a plurality of devices,
wherein the receiving process further provides a user with a unique representation method as a selectable function, the unique representation method indicating that processing contents are targeted for one or more devices of a same type among the plurality of devices.

2. The non-transitory recording medium according to claim 1, wherein the receiving process provides the user with a unique representation method for a predetermined process as a selectable function, the unique representation method indicating that the predetermined process is executed for the one or more devices of the same type.

3. The non-transitory recording medium according to claim 1, wherein the receiving process provides the user with a unique representation method for a device variable, included in processing contents of a predetermined process, as a selectable function, the unique representation method indicating that a statistic is calculated for variables of any or all of the one or more devices of the same type.

4. The non-transitory recording medium according to claim 1, wherein the receiving process provides the user with a unique representation method for a conditional statement, included in processing contents of a predetermined process, as a selectable function, the unique representation method indicating that the conditional statement is determined for any or all of the one or more processes of the same type.

5. The non-transitory recording medium according to claim 1, further causing the computer to execute a generation process for generating a source code from the processing contents received in the receiving process.

6. The non-transitory recording medium according to claim 5, wherein the generation process complements the processing contents based on the unique representation method when generating the source code, the unique representation method being selected by the user.

7. The non-transitory recording medium according to claim 1, further causing the computer to execute a determination process for determining consistency of the processing contents based on the unique representation method, the unique representation method being selected by the user.

8. A specification description method comprising:
a receiving process for receiving processing contents of a plurality of processes to be executed in a plurality of devices,
wherein the receiving process further provides a user with a unique representation method as a selectable function, the unique representation method indicating that processing contents are targeted for one or more devices of a same type among the plurality of devices.
